(19) United States
(12) Patent Application Publication
(10) Pub. No.: US 2009/0286081 A1
(43) Pub. Date: Nov. 19, 2009

(54) System and method for manufacturing natural looking and feeling wicker yarn

(76) Inventor: Jingming Ji, Zhejiang (CN)

Correspondence Address: SCHEIN & CAI LLP;James Cai, 111 W. ST. JOHN ST., SUITE 1250, SAN JOSE, CA, 95113, US

(21) Appl. No.: 12/152,360

(22) Filed: May 15, 2008

(51) Int. Cl. D02G 3/00; D01H 13/26; A01N 3/00

(52) U.S. Cl. 428/375; 57/282; 428/17

(57) ABSTRACT

A system to form smooth synthetic wicker yarn. The smooth synthetic wicker yarn is then reprocessed to form a naturally looking and feeling wicker yarn. In one aspect, a pair of top and bottom brushes with bristles score simultaneously a plurality of irregular hair lines in the circumferential outer surface of the smooth synthetic wicker yarn to texture the smooth synthetic wicker yarn to have a natural wicker appearance.

### BACKGROUND OF THE INVENTION

I. Field

This invention relates generally to synthetic yarn and, more specifically, to system and method for manufacturing textured synthetic wicker yarn that has the look and feel of natural wicker.

II. Background

Currently, the polymer wicker yarn is extruded to different sixes and shapes according to its use in a particular article of manufacture such as chairs, sofas, etc. But the surface of the polymer wicker yarn is relatively smooth, carrying distinct character of plastic. It lacks of natural aesthetic feeling and look of the natural wicker.

Wicker furniture has always been very popular and has been used as children's furniture, as well as, patio furniture. However, natural wicker has a limited life cycle in the outdoors as the weather affects the strength and durability of the wicker. For example, the wicker is susceptible to rotting as the result of exposure to rain. Moreover, natural wicker is generally painted to provide consumers a variety of colors to match their home decor. However, the expansion and contraction properties of natural wicker such as based on varying temperatures or swelling from being soaked by rain, causes the painted coating on the wicker to crack and peel.

Because of the popularity of wicker furniture, many attempts have been made to create a synthetic wicker that is more durable when exposed to the weather and aesthetically pleasing for current outdoor living spaces. However, the synthetic wicker yarns are generally smooth and do not have a natural wicker feel and look.

Therefore there is a need for techniques to create textured wicker yarn that has a natural wicker look and feel.

### SUMMARY

The present invention provides a method and system for mixing raw material and a coloring agent; extruding the mixture into wicker yarn; and scoring with rotating brushes a circumferential outer surface of the extruded wicker yarn to texture the wicker yarn to have a natural wicker look and feel.

The present invention contemplates a system comprising a mixer operable to mix raw synthetic material and a coloring agent to form a mixture; an extruder operable to extrude the mixture into smooth synthetic wicker yarn; and a pair of top and bottom brushes with bristles being operable to score simultaneously a plurality of hair lines in the circumferential outer surface of the smooth synthetic wicker yarn to texture the smooth synthetic wicker yarn to have a natural wicker appearance.

A wicker yarn, in one configuration, is provided that comprises an elongated section of molded synthetic material having formed therein irregular lines, crevices and radiating therefrom hairs of the synthetic material, the hairs created by scoring of the irregular lines and crevices in the synthetic material.

In addition to the above objects and features, additional objects, features and advantages will become apparent in view of the specification, drawings and appended claims.

### BRIEF DESCRIPTION OF THE DRAWINGS

FIG. 1 illustrates a high level block diagram of a system for making textured synthetic wicker yarn in accordance with one embodiment of the present invention.

FIG. 2 illustrates a flowchart of a process for making textured synthetic wicker yarn in accordance with one embodiment of the present invention.

FIG. 3 illustrates a smooth synthetic wicker yarn in accordance with one embodiment of the present invention.

FIG. 4 illustrates brushes texturizing the synthetic wicker yarn in accordance with one embodiment of the present invention.

FIG. 5 illustrates a weave pattern using the textured synthetic wicker yarn in accordance with one embodiment of the present invention.

### DETAILED DESCRIPTION

The present invention now will be described more fully hereinafter which reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware pieces. The following description is, therefore, not to be taken in a limiting sense.

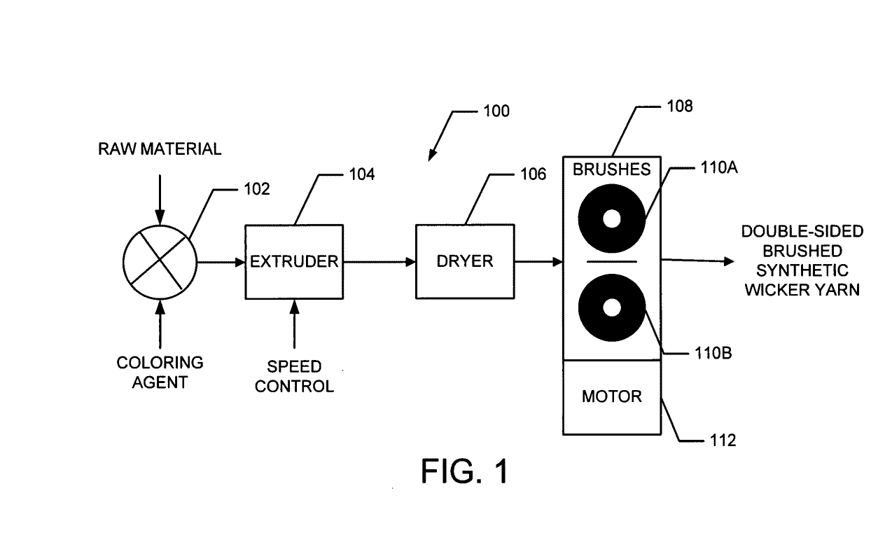

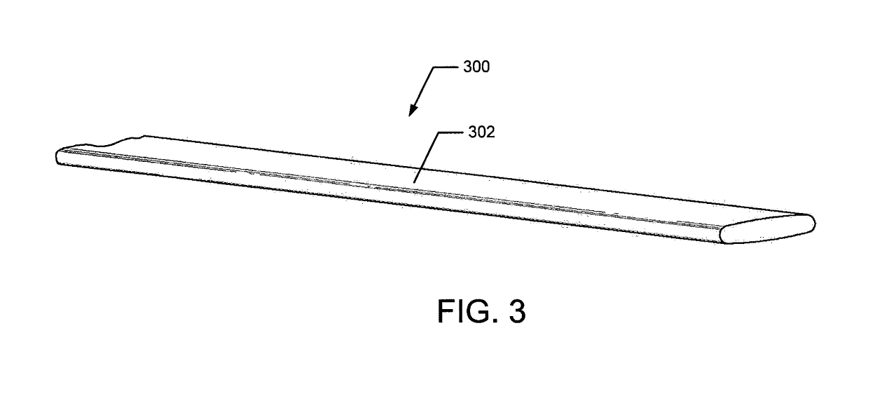

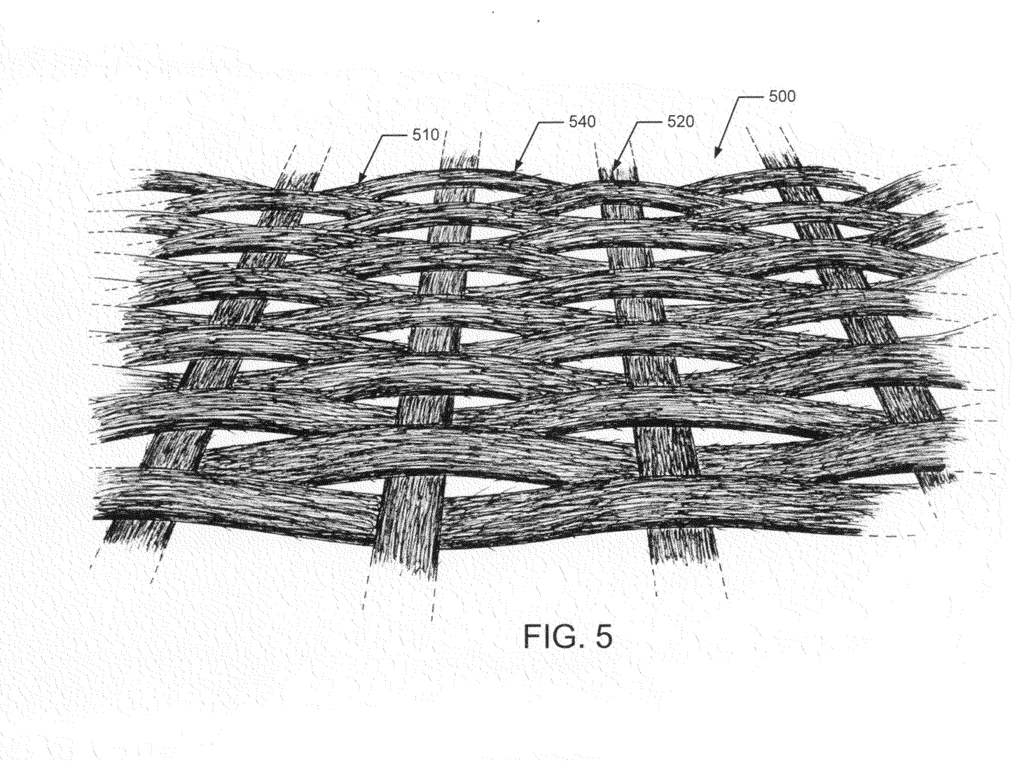

FIG. 1 illustrates a high level block diagram of a system 100 for making textured synthetic wicker yarn in accordance with one embodiment of the present invention. The system 100 includes a mixer 102 for mixing raw material (e.g. polyvinyl chloride (PVC) or polyethylene (PE)) and a coloring agent to provide pigment to the textured synthetic wicker yarn 510 or 520 of FIG. 5. The mixer 102 is followed by an extruder 104 for extruding the mixture to create a smooth synthetic wicker yarn 300 (FIG. 3). As best seen in FIG. 3, the smooth synthetic wicker yarn 300 is a relatively smooth yarn with little to no grooves, pocks, hair line crevices, etc. in or along a section of the outer surface of the synthetic wicker yarn. The extruder 104 is followed by a dryer 106 for drying the synthetic wicker yarn 300 so that it is generally set in shape and has a smooth surface texture. The term “set” refers to a yarn that will not become distorted under normal handling procedure. In one configuration, the synthetic wicker yarn 300 is flexible to permit weaving.

The dryer 106 is followed brushes 108 rotated via motor 112. In one configuration, there is at least one top brush 110A and at least one bottom brush 110B. The brushes 110A and 110B include bristles 420 wherein as the brushes 110A and 110B or 410A and 410B are rotated, as the synthetic wicker yarn 300 is traverses between the top and bottom brushes, the bristles 420 create, grooves, pocks, hair line crevices, etc. and texturizes simultaneously the outer surface of the synthetic wicker yarn 300. In one configuration, the bristles 420 of the brushes are capable of contacting 360 degrees of the outer surface 302 of wicker yarn 300. Hence, the entire circumferential outer surface 302 is texturized to have a look and feel of natural wicker.

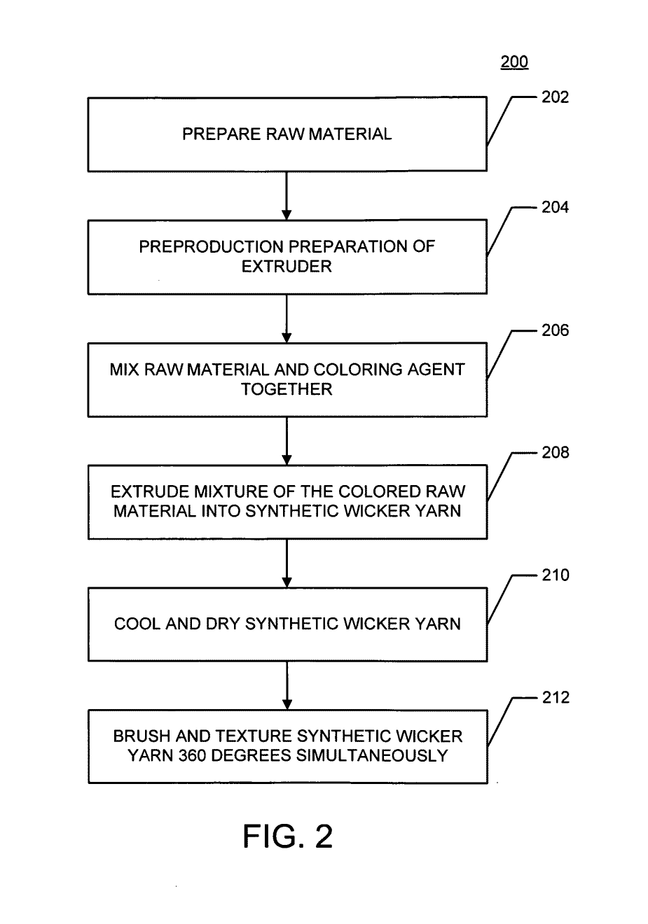

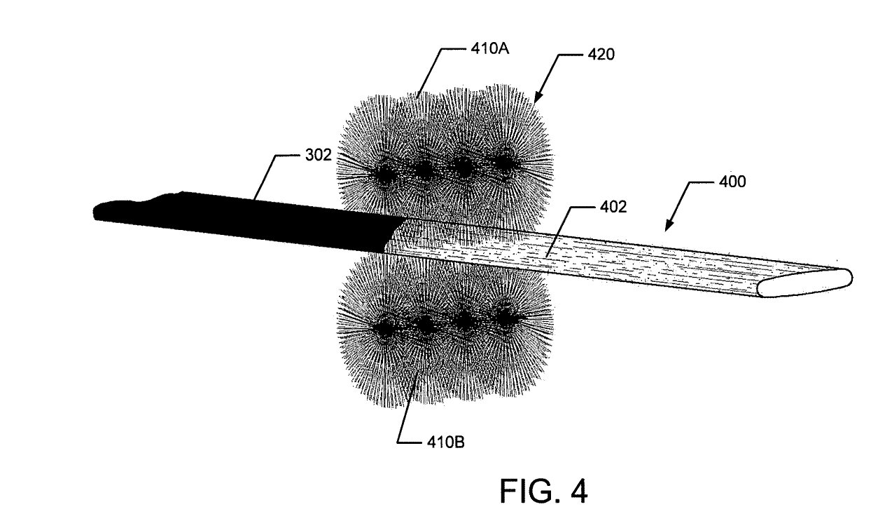

FIG. 2 illustrates a flowchart of a process 200 for making textured synthetic wicker yarn in accordance with one embodiment of the present invention. The process 200 will be described in combination with FIGS. 3 and 4. The process 200 begins with block 202 where the raw material is prepared. Preparation of raw materials is made according to standards and desired rigidity of wicker yarn. According to current color trends, a coloring agent or paint is prepared. At block 204, pre-production preparation of the extruder 104 to extrude a predetermined size and shape of the synthetic wicker yarn 300 takes place. During pre-production preparation of the extruder 104, the raw materials are placed into relevant moulds. Meanwhile, the temperature of extruder 104 is raised to the process temperature between 150° C.-200° C. At block 206, the raw material and the coloring agent are mixed. After the raw materials and coloring agents are mixed, the mixture is put into a funnel of the extruder 104.

At block 208, the mixture is extruded where the mixture of raw materials and coloring agent is smelt down to ropy liquids. The smooth wicker yarn 300 (FIG. 3) is created after molding, while the standard and size are control by the speed of extruder 104. At block 210, the extruded wicker yarn is cooled and dried. The smooth wicker yarn 300 is finalized and set after cooling.

Referring now to FIG. 4, at block, 212, the synthetic wicker yarn 300 is brushed 360° (360 degrees) in a single pass of the synthetic wicker yarn 300 between top and bottom brushes 410A and 410B. In order to make the smooth wicker yarn 300 look similar to natural wicker, the smooth wicker yarn 300 is reprocessed in order to change the texture the outer circumferential surface 302. In one configuration, the texture is created by two or more of rounded steel brushes, driven by frequency conversion electromotor groups (motor 112). The smooth wicker yarn 300 passes through high speed running steel brushes 410A and 410B, and at the same time towing it by a traction engine in reverse direction so as to score, engrave or inscribe irregular hair lines, grooves or crevices in the outer circumferential surface 302 with the steel brushes 410A and 410B. Therefore, the irregular hairs and/or other irregular formations such as grooves, pocks, crevices, etc. will appear on the outer circumferential surface denoted at 402 of partially textured synthetic wicker yarn 400.

FIG. 5 illustrates a weave pattern 500 using the textured synthetic wicker yarn in accordance with one embodiment of the present invention. The weave pattern 500 includes a plurality of horizontal textured wicker yarn 510 and a plurality of vertical textured wicker yarn 520. As can be readily seen in FIG. 5, as the brushes score, engrave or inscribe irregular hair lines, grooves or crevices in the outer circumferential surface 302, the shavings of the scoring and engraving may remain affixed to the textured outer circumferential surface 402 and form hairs 540.

According to this invention, the weave pattern 500 or other weave patterns may be used to manufacture articles such as leisure furniture so that the furniture will look more natural look and feel. Numerous styles of weave are used in the manufacture of wicker furniture. The various styles of weave result in a different look, feel, strength and weight of the finished woven product. In the weave pattern 500, the warp yarns are spaced apart and arranged parallel to each other. The weft yarns are woven over and under alternating warp yarns. Adjacent weft yarns pass on opposite sides of a given warp yarn.

The previous description of the present invention is provided to enable a person skilled in the art to make or use the invention. Various modifications to these configurations will be readily apparent to those skilled in the art, and the principles defined herein may be applied to other configurations without departing from the spirit or scope of the disclosure. Thus, the disclosure is not intended to be limited to the embodiments shown but is to be accorded the broadest scope consistent with the principles and features disclosed herein above.

What is claimed is:

1. A system comprising:
a mixer operable to mix raw synthetic material and a coloring agent to form a mixture;
an extruder operable to extrude the mixture into smooth synthetic wicker yarn; and
a pair of top and bottom brushes with bristles being operable to score simultaneously a plurality of hair lines in the circumferential outer surface of the smooth synthetic wicker yarn to texture the smooth synthetic wicker yarn to have a natural wicker appearance.

2. The system according to claim 1, further comprising a dryer operable to dry the smooth synthetic wicker yarn.

3. The system according to claim 1, wherein the pair of top and bottom brushes are operable to score simultaneously along a section of the circumferential outer surface with irregular hair lines.

4. The system according to claim 3, wherein during scoring one or more of shavings created by the scoring remain affixed to the circumferential outer surface to form hairs.

5. The system according to claim 1, wherein during scoring one or more of shavings created by the scoring remain affixed to the circumferential outer surface to form hairs.

6. The system according to claim 1, wherein the pair of the top and bottom brushes are operable to carve a plurality of irregular formations in the circumferential outer surface.

7. A system comprising:
means for mixing raw synthetic material and a coloring agent to form a mixture;
means for extruding the mixture into smooth synthetic wicker yarn;
means for first scoring a plurality of hair lines in and along a top portion of a circumferential outer surface of the smooth synthetic wicker yarn to texture the smooth synthetic wicker yarn to have a natural wicker appearance; and
means for second scoring a plurality of hair lines in and along a bottom portion of a circumferential outer surface of the smooth synthetic wicker yarn to texture the smooth synthetic wicker yarn to have the natural wicker appearance.

8. The system according to claim 7, further comprising mean for drying the smooth synthetic wicker yarn.

9. The system according to claim 7, wherein the first and second scoring means are operable to perform scoring simultaneously along a section of the circumferential outer surface with irregular hair lines.

10. The system according to claim 9, wherein during scoring one or more of shavings created by the scoring remain affixed to the circumferential outer surface to form hairs.

11. The system according to claim 7, wherein during scoring one or more of shavings created by the scoring remain affixed to the circumferential outer surface to form hairs.

12. The system according to claim 7, wherein the first and second scoring means are further operable to perform carving of a plurality of irregular formations in the circumferential outer surface.

13. A method comprising:
mixing raw synthetic material to form a mixture;
extruding the mixture into smooth synthetic wicker yarn;
scoring with a first rotating brush a plurality of hair lines in and along a top portion of a circumferential outer surface of the smooth synthetic wicker yarn to texture the smooth synthetic wicker yarn to have a natural wicker appearance; and
scoring with a second rotating brush a plurality of hair lines in and along a bottom portion of the circumferential outer surface of the smooth synthetic wicker yarn to texture the smooth synthetic wicker yarn to have the natural wicker appearance.

14. The method according to claim 13, further comprising drying the smooth synthetic wicker yarn.

15. The method according to claim 13, wherein the scoring of the top portion is performed simultaneously with the scoring of the bottom portion to perform scoring simultaneously along a section of the circumferential outer surface with irregular hair lines.

16. The method according to claim 15, further comprising during the scoring of the top portion and the scoring of the bottom portion, forming hairs from one or more of shavings remaining affixed to the circumferential outer surface.

17. The method according to claim 13, further comprising during the scoring of the top portion and the scoring of the bottom portion, forming hairs from one or more of shavings remaining affixed to the circumferential outer surface.

18. The method according to claim 13, further comprising during the scoring of the top portion and the scoring of the bottom portion, forming irregular formations in the circumferential outer surface.

19. A wicker yarn comprising:
an elongated section of molded synthetic material having formed therein irregular lines, crevices and radiating therefrom hairs of the synthetic material, the hairs created by scoring of the irregular lines and crevices in the synthetic material.

20. The wicker yarn according to claim 19, wherein the synthetic material comprises polyvinyl chloride (PVC) or polyethylene (PE).

21. The wicker yarn according to claim 20, wherein the synthetic material is flexible.

22. The wicker yarn according to claim 19, wherein the synthetic material comprises a coloring agent.
